(19) United States
(12) Patent Application Publication
(10) Pub. No.: US 2006/0181756 A1
(43) Pub. Date: Aug. 17, 2006

(54) Light scanning device and image display apparatus

(75) Inventor: Tetsuro Yamazaki, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/304,547

(22) Filed: Dec. 16, 2005

(30) Foreign Application Priority Data
Feb. 16, 2005 (JP) 2005-038734

(51) Int. Cl. G02B 26/08

(52) U.S. Cl. 359/212; 359/198

(57) ABSTRACT

A light scanning device including: a light source that supplies light in the form of a beam; a reflection mirror that reflects the light beam from the light source; and a movable member that is provided integrally with the reflection mirror and displaces the light beam reflected from the reflection mirror so as to be scanned in a first direction and in a second direction substantially orthogonal to the first direction, the movable member being displaced so that a frequency to scan the light beam in the first direction is higher than the frequency to scan the light beam in the second direction, the reflection mirror being displaced not only in association with the movable member but also for allowing the light beam to be scanned in a direction different from the first direction and correcting the position of the light beam to be scanned in accordance with displacement of the movable member.

### BACKGROUND

1. Technical Field

The present invention relates to a light scanning device and an image display apparatus and, more specifically, to a technique relating to a light scanning device that displays an image by scanning a laser beam modulated according to image signals.

2. Related Art

A laser printer or a display device that displays an image by scanning a laser beam employs a light scanning device that scans the laser beam. The light scanning device changes the direction of travel of the laser beam from a light source by displacing a reflection mirror that reflects the laser beam. Scanning of the laser beam may be achieved, for example, by a polygon mirror that rotates a plurality of reflection mirrors. Since high-speed printing by the laser printer and high-resolution image display on the display device are increasingly required, the light scanning device is required to be able to scan the light beam at high speeds correspondingly. In order to scan the light at high speeds with the polygon mirror, the polygon mirror may be rotated at high-speeds. However, the polygon mirror tends to be inclined or deflected due to displacement of a center of gravity thereof or an effect of a centrifugal force as the rotational speed increases. When inclination or deflection of the mirror occurs, it is difficult for the light scanning device to scan the laser beam to a correct position. As a structure for scanning the light with means other than the polygon mirror, there is a structure that causes oscillations on an singular reflection mirror. In this structure, the size and weight may be reduced in comparison with the plurality of polygon mirrors. Therefore, with the independent reflection mirror, stable and high-speed driving is achieved. By driving the reflection mirror at a resonance frequency, the laser beam can be scanned at a large amplitude with the compact reflection mirror.

When forming or displaying an image by scanning the laser beam, the light scanning device is required to scan the laser beam two-dimensionally. In order to scan the laser beam two-dimensionally using the reflection mirror, for example, scanning in the horizontal direction is performed by resonating the reflection mirror, and then scanning in the vertical direction is performed at a speed slower than that in scanning in the horizontal direction. In this case, since the position of the laser beam moves in the vertical direction as well while the laser beam is scanned once in the horizontal direction, the laser beam is scanned so as to draw a sine curve shaped track. Therefore, the incoming position of the laser beam is displaced in the vertical direction while the laser beam is scanned once in the horizontal direction. When printing or displaying an image in which pixels are arranged two-dimensionally in a matrix manner, the displacement may result in quality deterioration of the image. In addition, it is difficult to regenerate a new image signal corresponding to the incoming position of the laser beam in order to correct the displacement of the position of the laser beam. In order to correct the displacement of the incoming position of the laser beam as described above, provision of a correction mirror in addition to the reflection mirror is proposed. A technique to provide a mirror for correcting displacement of the position of the incoming laser beam is proposed, for example, in JP-T-2003-513332.

According to the technique proposed in JP-T-2003-513332, the correction mirror is provided at a position different from the position of the reflection mirror for scanning the laser beam in the two-dimensional direction. However, provision of two scanning devices in one light scanning device may result in increase in size of the light scanning device. Also, since provision of the two mirrors may complicate the structure and make adjustment of optical axis difficult, the manufacturing cost may increase. In this manner, there is a problem that it is difficult to scan the laser beam accurately corresponding to the arrangement of pixels when the laser beam is scanned in the two-dimensional direction even with the technique in the related art.

### SUMMARY

An advantage of some aspects of the invention is to provide a light scanning device which can scan a light beam accurately corresponding to two-dimensionally arranged pixels and an image display apparatus which can display high quality images.

According to a first aspect of the invention, a light scanning device including a light source that supplies light in the form of a beam, a reflection mirror that reflects the light beam from the light source, a movable member that is provided integrally with the reflection mirror and displaces the light beam reflected from the reflection mirror so as to be scanned in a first direction and in a second direction substantially orthogonal to the first direction, the movable member being displaced so that a frequency to scan the light beam in the first direction becomes higher than the frequency to scan the light beam in the second direction, the reflection mirror being displaced not only in association with the movable member but also for allowing the light beam to be scanned in a direction different from the first direction and correcting the position of the light beam to be scanned in accordance with displacement of the movable member.

The reflection mirror scans the light beam from the light source two-dimensionally by being displaced in association with the displacement of the movable member. The reflection mirror moves the position to scan the light beam also in the second direction while it scans the light beam once in the first direction. Therefore, when the reflection mirror is displaced in association with the displacement of the movable member, the light beam from the light source is scanned so as to draw a sine curve shaped track. According to the first aspect of the invention, the reflection mirror is displaced in association with the movable member, and is also displaced to correct the position of the light beam. The reflection mirror is displaced so as to allow the light beam to be scanned in a direction different from the first direction to correct the position in the second direction of the light beam being scanned in the first direction. For example, when printing or displaying an image having pixels arranged two-dimensionally in a matrix manner, vertical displacement of the light beam being scanned in the horizontal direction can be corrected. In this manner, accurate scanning of the light beam corresponding to the two-dimensionally arranged pixels is achieved. With structure in which the position of the light beam to be scanned is corrected using the reflection mirror provided integrally with the movable member, upsizing or complication in structure of the light scanning device can be avoided. Accordingly, the light scanning device which can scan the light beam accurately corresponding to the two-dimensionally arranged pixels is provided.

It is preferable that the reflection mirror corrects the position of the light beam to be scanned by being displaced so as to allow the light beam to be scanned in the second direction. By being displaced so as to scan the light beam in the second direction, the position of the light beam in the second direction can be corrected. Accordingly, the position of the light beam being scanned in the first direction can be corrected with respect to the second direction. It is more preferable that the reflection mirror corrects the position of the light beam by scanning the light beam in a direction opposite from the direction in which the movable member scans the light beam in the second direction. Accordingly, the light beam can be scanned further accurately corresponding to the arrangement of the pixels.

It is preferable that the reflection mirror corrects the position of the light beam to be scanned by being displaced at a higher frequency than a frequency at which the movable member is displaced to scan the light beam in the first direction. When the reflection mirror is displaced at the frequency higher than the frequency of displacement to scan the light beam in the first direction, the position of the light beam to be scanned can be corrected. Accordingly, the position of the light beam to be scanned can be corrected.

It is preferable that the reflection mirror corrects the position of the light beam to be scanned by being displaced at a frequency which corresponds to substantially twice the frequency at which the movable member is displaced to scan the light beam in the first direction. Accordingly, the position of the laser beam can be corrected every time when the laser beam is scanned in the first direction, whereby the position of the laser beam can be aligned with the arrangement of the pixels.

It is preferable that a first drive unit that drives the movable member and a second drive unit that drives the reflection mirror for correcting the position of the light beam are provided. By the provision of the second drive unit separately from the first drive unit, the reflection mirror can be driven to correct the position of the laser beam separately from driving of the movable member. Since the amount of displacement for correcting the position of the light beam may be significantly small in comparison with the displacement of the movable member, the second drive unit can be simplified and downsized. Therefore, for example, the second drive unit can be provided integrally with the movable member. Accordingly, the position of the light beam to be scanned can be corrected.

It is preferable that the drive unit that drives the movable member is provided, and the reflection mirror is displaced so as to correct the position of the light beam to be scanned using oscillations from the movable member that is driven by the drive unit. Since the reflection mirror is displaced so as to correct the position of the light beam using the oscillations from the movable member, a specific drive unit for correction is not necessary. Accordingly, the position of the light to be scanned can be corrected by a further simple structure.

According to a second aspect of the invention, a light scanning device including: a light source that supplies a light beam, a reflection mirror that reflects the light beam from the light source and is displaced so that the reflected light beam is scanned in a first direction and a second direction substantially orthogonal to the first direction, the reflection mirror being displaced so that a frequency to scan the light beam in the first direction becomes higher than a frequency to scan the light beam in the second direction, and correcting the position of the light beam to be scanned by resonating so as to allow the light beam to be scanned in a direction different from the first direction at a frequency higher than the frequency to scan the light beam in the first direction.

The reflection mirror moves the position to which the light beam is scanned also in the second direction while the light beam is scanned once in the first direction. When the positional correction of the light beam to be scanned is not performed, the light beam from the light source is scanned so as to draw a sine curve shaped track. According to the second aspect of the invention, the reflection mirror is also displaced so as to correct the position of the light beam. The reflection mirror corrects the position of the light beam being scanned in the first direction with respect to the second direction by being displaced so as to allow the light beam to be scanned in a direction different from the first direction. For example, when printing or displaying an image having pixels arranged two-dimensionally in a matrix manner, vertical positional displacement of the light beam scanned in the horizontal direction can be corrected. In this manner, the light beam can be scanned accurately corresponding to the two-dimensionally arranged pixels. When the reflection mirror is resonated at the frequency higher than the frequency of displacement so as to allow the light beam to be scanned in the first direction, the position of the light beam to be scanned can be corrected. Since it is not necessary to provide an additional mirror for correcting the position of the light beam to be scanned, upsizing or complication of the structure of the light scanning device can be avoided. Accordingly, the light scanning device which can scan the light beam accurately corresponding to the arrangement of the pixels is provided.

It is preferable that a drive unit that drives the reflection mirror is provided and the reflection mirror corrects the position of the light beam to be scanned according to a driving force generated by the drive unit. The reflection mirror can be not only displaced so as to allow the light beam to be scanned in the first direction and the second direction, but also resonated so as to allow the light beam to be scanned in the direction different from the first direction by using a driving force generated by the drive unit such as an electrostatic force, an expansion force of a piezoelectric element, or an electromagnetic force. In order to drive the reflection mirror by the electrostatic force, a structure of applying voltage between the reflection mirror and an electrode, which is the drive unit, can be employed. In order to drive the reflection mirror by the expansion force of the piezoelectric element, a structure of applying voltage to the piezoelectric element, which is the drive unit, can be employed. In order to drive the reflection mirror by the electromagnetic force, a structure of providing a coil and a magnet as the drive unit and supplying electric current to the coil can be employed. Accordingly, the position of the light beam to be scanned can be corrected.

It is preferable that a plurality of the drive units are provided and that the reflection mirror corrects the position of the light beam to be scanned by adjusting the magnitude of the driving force for each drive unit. For example, when the reflection mirror is driven by using the electrostatic force, the magnitude of the electrostatic force can be adjusted according not only to the voltage applied between the reflection mirror and the electrode, but also, for example, to the size of the electrode, or the distance between the electrode and the reflection mirror. When the reflection mirror is driven by using the expansion force of the piezoelectric element, the magnitude of the expansion force of the piezoelectric element can be adjusted according to the voltage applied to the piezoelectric element or the size of a piezoelectric material. When the reflection mirror is driven by the electromagnetic force, the magnitude of the electromagnetic force can be adjusted according to the amount of electric current to be supplied to the coil, the number of turns of the coil, and the strength of the magnet. By adjusting the magnitude of the drive force for each drive unit, a state in which the reflection mirror can resonate so as to allow the light beam to be scanned in a direction different from the first direction can be created. Accordingly, the reflection mirror can be resonated so as to allow the light beam to be scanned in the direction different from the first direction.

It is preferable that an axis of rotation for oscillating the reflection mirror so as to allow the light beam to be scanned in the first direction is provided and the reflection mirror corrects the position of the light beam to be scanned by adjusting at least one of the shape of the axis of rotation and the position to provide the axis of rotation. Adjustment of the shape of the axis of rotation is achieved, for example, by differentiating the thickness or the length of the axis of rotation. Adjustment of the position to provide the axis of rotation is achieved, for example, by providing the axis of rotation at a position different from a centerline of the reflection mirror. In this manner, the state in which the reflection mirror can resonate so as to allow the light beam to be scanned in the direction different from the first direction can be created. Accordingly, the reflection mirror can be resonated as to allow the light beam to be scanned in the direction different from the first direction.

According to a third aspect of the invention, an image display apparatus including the aforementioned light scanning device wherein an image is displayed on a predetermined surface by the light beam from the light scanning device is provided. With the aforementioned light scanning device, the light beam can be scanned accurately corresponding to the two-dimensionally arranged pixels. Accordingly, the image display apparatus which can display high-quality images is provided.

### BRIEF DESCRIPTION OF THE DRAWINGS

The invention will be described with reference to the accompanying drawings, wherein like numbers reference like elements.

FIG. 1 shows a schematic structure of an image display apparatus according to a first embodiment of the invention.

FIG. 2A shows a schematic structure of a scanning unit.

FIG. 2B is an explanatory drawing showing a structure for driving a movable unit and a reflection mirror

FIG. 3 is an explanatory drawing showing a track of a laser beam to be scanned by displacement of the movable unit.

FIG. 4 is an explanatory drawing showing correction of the position of the laser beam by displacement of the reflection mirror.

FIG. 5 is an explanatory drawing showing displacement of the reflection mirror for correcting the position of the laser beam.

FIG. 6 shows a schematic structure of a principal portion of the scanning unit according to a modification of the first embodiment.

FIG. 7 shows a schematic structure of the scanning unit according to a modification of the first embodiment.

FIG. 8 shows a schematic structure of a principal portion of the scanning unit according to a modification of the first embodiment.

FIG. 9 is an explanatory drawing showing correction of the position of the laser beam by a light scanning device according to a second embodiment.

FIG. 10 shows a schematic structure of a principal portion of the scanning unit according to the second embodiment.

FIG. 11 is a drawing showing a structure in which the magnitude of an electrostatic force is adjusted by differentiating the size of an electrode.

FIG. 12 is an explanatory drawing showing a structure in which the distances of the reflection mirror from the respective electrodes are differentiated.

FIG. 13 is an explanatory drawing showing a structure in which torsion springs having different thicknesses are used.

FIG. 14 is an explanatory drawing showing a structure in which torsion springs having different lengths are used.

FIG. 15 is a drawing showing a structure in which the torsion springs are provided at positions other than on a centerline of the reflection mirror.

FIG. 16 is an explanatory drawing showing correction of the position of the laser beam by displacement of the reflection mirror.

FIG. 17 is a schematic structure of an image display apparatus according to a third embodiment of the invention.

### DESCRIPTION OF EXEMPLARY EMBODIMENTS

Referring now to the drawings, embodiments of the invention will be described in detail.

### First Embodiment

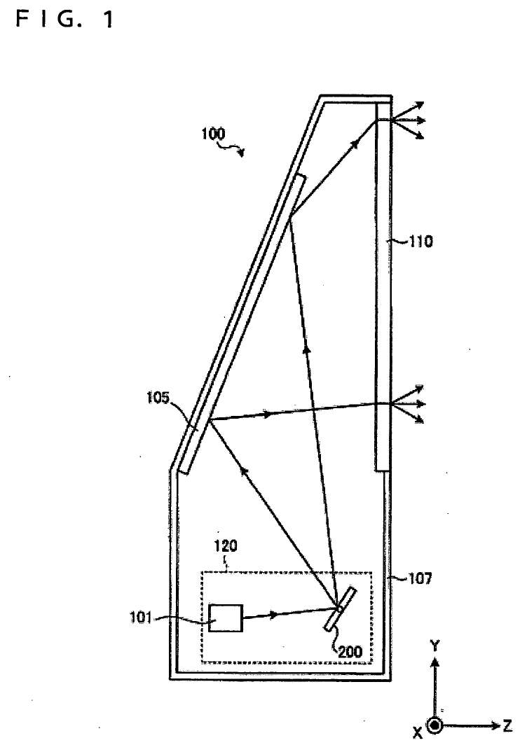

FIG. 1 shows a schematic drawing of an image display apparatus 100 according to a first embodiment of the invention. The image display apparatus 100 is a so-called rear projector configured in such a manner that a laser beam is supplied on one of the surfaces of a screen 110 and a viewer observes the light beam emitted from the other surface of the screen 110 to see an image. A light scanning device 120 provided in the image display apparatus 100 causes the laser beam to be scanned by a scanning unit 200. The image display apparatus 100 displays the image on the screen 110 surface which is a predetermined surface by the light beam from the light scanning device 120.

A light source 101 supplies a red laser beam, a green laser beam, and a blue laser beam, as light in the form of a beam, after having modulated according to image signals. The light source 101 may employ a semiconductor laser or a solid laser provided with a modulating section for modulating the laser beam. The modulation according to the image signal may be performed by any of amplitude modulation or pulse width modulation. On the light emitting side of the light source 101, a shaping optical system for shaping the laser beam into, for example, a beam shape of 0.5 mm in diameter may be provided.

The scanning unit 200 causes the laser beam from the light source 101 to be scanned. Detailed structure of the scanning unit 200 will be described later. The laser beam from the scanning unit 200 is directed to a reflecting section 105. The reflecting section 105 is provided on an inner surface of an enclosure 107 at a position opposing the screen 110. The laser beam directed to the reflecting section 105 is reflected toward the screen 110. The internal space of the enclosure 107 is sealed. The screen 110 is provided on a predetermined surface of the enclosure 107. The screen 110 is a transmissive screen which allows the laser beam from the light scanning device 120 modulated according to the image signal to pass through. The light beam from the reflecting section 105 enters the screen 110 from the surface thereof on the inner side of the enclosure 107, and then emitted from the surface on the viewer's side. The viewer observes the light emitted from the screen 110 to see the image.

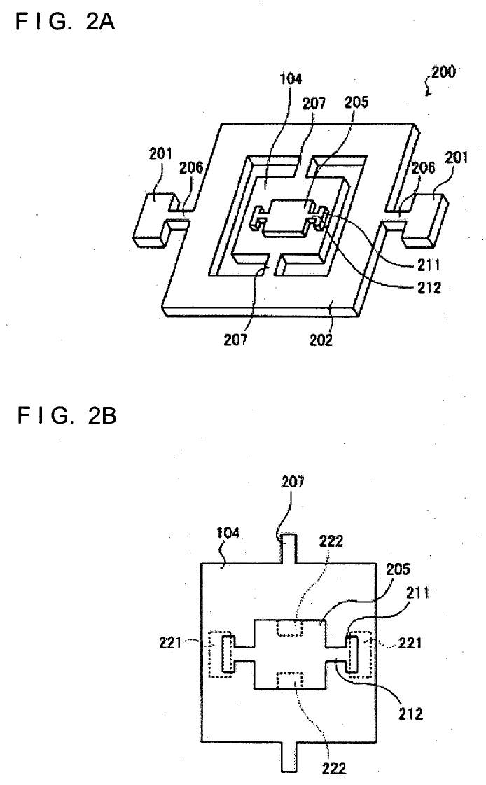

FIG. 2A shows a schematic structure of the scanning unit 200. The scanning unit 200 has a so-called double gimbal structure having a movable member 104 and an, outer frame 202 provided around the movable member 104. The outer frame 202 is connected to fixed portions 201 by a first torsion spring 206 as an axis of rotation. The outer frame 202 rotates about the first torsion spring 206. The movable member 104 is connected to the outer frame 202 by a second torsion spring 207 as an axis of rotation which is substantially orthogonal to the first torsion spring 206.

The outer frame 202 rotates about the first torsion spring 206 using torsion and restoration to its original state of the first torsion spring 206. The movable member 104 is displaced to allow the laser beam reflected from the reflection mirror 205 to be scanned in X-direction by the rotation of the outer frame 202 about the first torsion spring 206. The movable member 104 rotates about the second torsion spring 207 using torsion and restoration to its original state of the second torsion spring 207. The movable member 104 is displaced so as to allow the laser beam reflected from the reflection mirror 205 to be scanned in Y-direction by rotating about the second torsion spring 207. In this manner, the movable member 104 is displaced so as to allow the laser beam reflected from the reflection mirror 205 to be scanned in the X-direction as a first direction and the Y-direction as a second direction which is substantially orthogonal to the first direction.

A reflection mirror 205 is provided on the surface of the movable member 104. The reflection mirror 205 reflects the laser beam from the light source 101. The reflection mirror 205 can be configured by forming a member of high reflectivity, for example, a metal thin film of aluminum, silver, or the like. The movable member 104 is provided integrally with the reflection mirror 205. The reflection mirror 205 scans the reflected laser beam in the X-direction and the Y-direction by being displaced in association with the movable member 104.

The reflection mirror 205 is connected to a fixed portion 211 on the movable member 104 by a third torsion spring 212 as an axis of rotation. The reflection mirror 205 is displaced so as to allow the light beam to be scanned in the Y-direction as the second direction by rotating about the third torsion spring 212. In this manner, the reflection mirror 205 corrects the position of the laser beam to be scanned by being displaced in association with the movable member 104 and furthermore, by being displaced so as to allow the light beam to be scanned in the second direction, which is the direction different from the first direction.

FIG. 2B is an explanatory drawing showing a structure for driving the movable member 104 and the reflection mirror 205. Assuming that a side where the reflection mirror 205 reflects the laser beam is a front side, electrodes 221 for the movable member are provided on a back side of the movable member 104 at positions substantially symmetry with respect to the second torsion spring 207 as the axis of rotation, respectively. The electrodes 221 for the movable member are a first drive unit that drives the movable member 104. When voltage is applied to the electrodes 221 for the movable member, a drive force according to the potential, for example, an electrostatic force is generated between the electrodes 221 for the movable member and the movable member 104. By applying the voltage alternately on the two electrodes 221 for the movable member, the movable member 104 rotates about the second torsion spring 207. The outer frame 202 also rotates about the first torsion spring 206 by generating an electrostatic force at positions substantially symmetry with respect to the first torsion spring 206 as in the case of the movable member 104. By the rotation of the outer frame 202 and the rotation of the movable member 104, the reflection mirror 205 is displaced so as to allow the laser beam to be scanned in the X-direction and the Y-direction.

In duration of one frame of an image, the movable member 104 is displaced so as to reciprocate the laser beam several times in the X-direction, while the laser beam is scanned once in the Y-direction. In this manner, the movable member 104 is displaced so that a frequency to scan the light beam in the X-direction as the first direction is higher than a frequency to scan the laser beam in the Y-direction as the second direction. In order to achieve high-speed scanning of the laser beam in the X-direction, the movable member 104 is preferably adapted to resonate about the second torsion spring 207. By resonating the movable member 104, the amount of displacement of the movable member 104 can be multiplicated. By multiplicating the amount of displacement of the movable member 104, the light scanning device 120 can scan the laser beam efficiently with a small quantity of energy.

The electrodes 222 for the reflection mirror is provided on the back side of the reflection mirror 205 at positions substantially symmetry with respect to the torsion spring 212 as the axis of rotation, respectively. The electrodes 222 for the reflection mirror are a second drive unit that drives the reflection mirror 205 so as to correct the position of the light beam to be scanned. The reflection mirror 205 also rotates about the third torsion spring 212 by applying voltage alternately to the two electrodes 222 for the reflection mirror as in the case of the movable member 104. The scanning unit 200 may be manufactured by, for example, MEMS (micro Electro Mechanical Systems) technique.

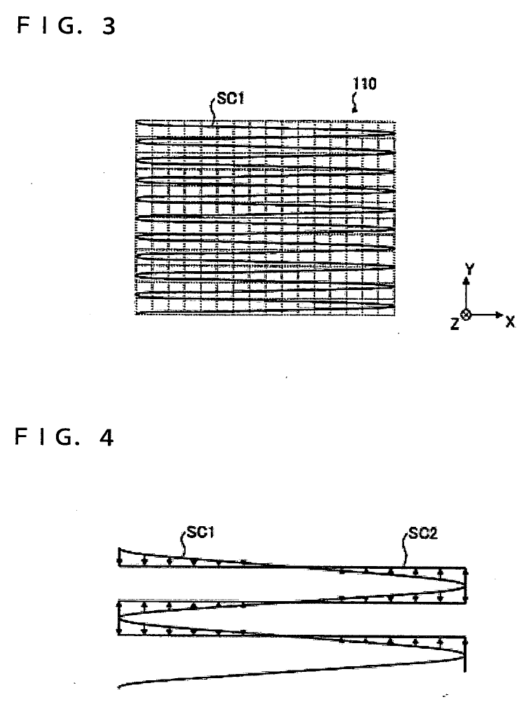

FIG. 3 is an explanatory drawing showing a track SC1 of the laser beam scanned by displacement of the reflection mirror 205 in association with the movable member 104 as a preprocess of correction of the position of the laser beam by the displacement of the reflection mirror 205. As described above, in duration of one frame of the image, the movable member 104 is displaced so as to reciprocate the laser beam by a plurality of times in the X-direction while the laser beam is scanned once in the Y-direction. While the laser beam is scanned once in the X-direction, the position of the laser beam moves also in the Y-direction at a slower speed than the movement of the laser beam in the X-direction. Therefore, the track SC1 of the laser beam assumes a sine curve shape as shown in FIG. 3.

In contrast, the pixels of the image displayed on the screen 110 are generally arranged two-dimensionally in the matrix manner. From these reasons, the position of the incoming laser beam is misaligned in the Y-direction while the laser beam is scanned once in the X-direction. Misalignment of the incoming position of the laser beam may deteriorate the quality of the image. Furthermore, it is difficult to generate new image signals according to the incoming position of the laser beam in order to correct the positional misalignment of the laser beam.

FIG. 4 is an explanatory drawing showing correction of the position of the laser beam by displacement of the reflection mirror 205. The reflection mirror 205 is displaced in association with the movable member 104, and also in the Y-direction as the second direction. When the reflection mirror 205 starts scanning of the laser beam in the X-direction in association with the movable member 104, the reflection mirror 205 corrects the position of the laser beam so as to deflect the laser beam downward in the drawing, which corresponds to a minus Y-direction. At this time, the reflection mirror 205 is displaced to position which deflects the laser beam to a minus-most position in the Y-direction to the maximum.

Subsequently, as the laser beam is scanned in the X-direction, the reflection mirror 205 moves the laser beam from the minus-most position in the Y-direction upward in the drawing, which corresponds to a plus Y-direction. When the scanning of the laser beam on one way in the X-direction is completed, the reflection mirror 205 corrects the position of the laser beam to be deflected upward to a position where the laser beam is deflected upward in the drawing, which corresponds to the plus Y-direction. At this time, the reflection mirror 205 is displaced to a position where the laser beam is deflected to a plus most position in the Y-direction. When scanning of the laser beam in the opposite X-direction is started, the reflection mirror 205 corrects the position of the laser beam to a position to deflect the laser beam is downward in the drawing, which corresponds to the minus Y-direction again. At this time, the reflection mirror 205 is displaced to a position where the laser beam is deflected downward in the drawing, which is the minus Y-direction again. Furthermore, as the laser beam is scanned in the X-direction, the reflection mirror 205 moves the laser beam from the minus most position in the Y-direction upward, which corresponds to the plus Y-direction.

The reflection mirror 205 corrects the position of the laser beam by scanning the laser beam in the plus Y-direction in contrast to the movable member 104 that scans the light beam in the minus Y-direction. In this manner, the reflection mirror 205 scans the laser beam in the direction opposite from the direction in which the movable member 104 allows the laser beam to be scanned in the second direction. Accordingly, the movement of the laser beam in the second direction caused by the movable member 104 is compensated, so that the position of the laser beam can be corrected to keep the position of the laser beam substantially the same in the second direction while the laser beam is scanned in the first direction. In this manner, the incoming position of the laser beam on the screen 110 is corrected from the track SC1 in the sine curve shape to follow a track SC2 in a shape similar to a rectangular wave.

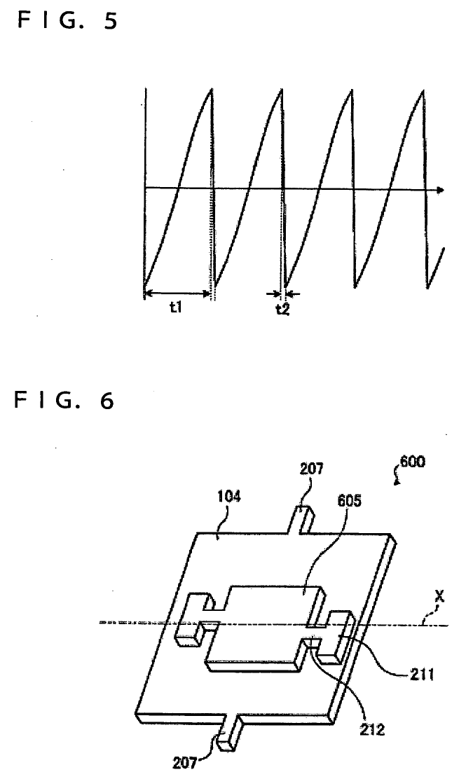

FIG. 5 is an explanatory drawing showing displacement of the reflection mirror 205 for correcting the position of the laser beam. The reflection mirror 205 is displaced from a state of deflecting the laser beam to the minus most position in the Y-direction to a state of deflecting the laser beam to the plus most position in the Y-direction while the laser beam is scanned in the X-direction in association with the movable member 104. The reflection mirror 205 is displaced in the same direction from the state of deflecting the laser beam to the minus most position in the Y-direction to the state of deflecting the laser beam to the plus most position in the Y-direction during a time period t1.

When the scanning of the laser beam in the X-direction is turned around, the reflection mirror 205 is returned to the state of deflecting the laser beam to the minus most position in the Y-direction again, and is displaced to a position to deflect the laser beam to the plus most position in the Y-direction. The reflection mirror 205 is displaced from the state of deflecting the laser beam to the plus most position in the Y-direction to the state of deflecting the laser beam to the minus most position in the Y-direction in a blink during a time period t2. Assuming that an axis of ordinate represents the position in the Y-direction and an axis of abscissas represents time, the displacement of the reflection mirror 205 is graphed out in a substantially triangular waveform as shown in FIG. 5. The reflection mirror 205 corrects the position of the laser beam to be scanned according to the displacement of the movable member 104 by repeating such displacement.

Positional correction of the laser beam can be achieved by causing the reflection mirror 205 to scan the laser beam at a scanning width smaller than that done by the movable member 104 in the X-direction. Resonance is not necessary for displacement of the reflection mirror 205 for the positional correction of the laser beam because the amount of displacement may be smaller than that of the movable member 104 and the reflection mirror 205 is compact by itself.

A cycle of displacement of the reflection mirror 205 for the positional correction of the laser beam is a sum of the time period t1 and the time period t2. The reflection mirror 205 repeats the same displacement twice for correcting the position of the laser beam while the movable member 104 is displaced for reciprocating the laser beam once in the X-direction. In this manner, the reflection mirror 205 corrects the position of the laser beam to be scanned by being displaced in the Y-direction at a frequency about twice the frequency for displacing the movable member 104 to allow the light beam to be scanned in the X-direction. Accordingly, the position of the laser beam can be corrected each time when the laser beam is scanned in the X-direction, so that the position of the laser beam can be adjusted corresponding to the arrangement of the pixels.

The position of the laser beam to be scanned is corrected using the reflection mirror 205 provided integrally with the movable member 104. In this arrangement, upsizing or complication in structure of the light scanning device 120 can be avoided. Accordingly, an advantage such that the light beam can be scanned accurately corresponding to the two-dimensionally arranged pixels is achieved. At the same time, high-quality images can be displayed by the image display apparatus 100.

The reflection mirror 205 is not limited to the structure of being displaced so as to allow the light beam to be scanned in the Y-direction at the frequency which substantially corresponds to twice the frequency for displacing the movable member 104 to allow the light beam to be scanned in the X-direction. The reflection mirror 205 must simply have a structure of being displaced at a frequency higher than the frequency for displacing the movable member 104 to allow the light beam to be scanned in the X-direction as the first direction. By displacing the reflection mirror 205 at the frequency higher than the frequency for the displacement to allow the laser beam to be scanned in the X-direction, the position of the laser beam to be scanned can be corrected.

The reflection mirror 205 is not limited to the structure in which the position of the laser beam to be scanned is corrected by displacement represented by the substantially triangular shape shown in FIG. 5. For example, the reflection mirror 205 can correct the position of the laser beam by displacement represented by the sine curve. In this case as well, the reflection mirror 205 can correct the track of the laser beam so as to approximate to the track SC2 of rectangular shape. Also, displacement for correcting the position of the laser beam can be performed at a substantially constant speed, so that the position of the laser beam can be corrected with a simple driving operation. In this case, the position of the laser beam can be corrected using resonance of the reflection mirror 205.

Furthermore, the light scanning device 120 is not limited to the structure in which the movable member 104 or the reflection mirror 205 is driven by the electrostatic force according to the potential. For example, the structure in which the reflection mirror 205 is driven by the electromagnetic force or by the extension force of the piezoelectric element may be employed. When the electromagnetic force is used, for example, by generating the electromagnetic force between the movable member 104 and the permanent magnet, or between the reflection mirror 205 and the permanent magnet depending on the electric current, the movable member 104 and the reflection mirror 205 can be driven.

FIG. 6 shows a schematic structure of a principal portion of a scanning unit 600 according to a modification of the first embodiment, illustrating the structures of the movable member 104 and the reflection mirror 605. The scanning unit 600 can be applied to the above-described light scanning device 120. The scanning unit 600 of the present modification is characterized in that a reflection mirror 605 is displaced so as to correct the position of the laser beam to be scanned using oscillations from the movable member 104. In this modification, the movable member 104 is driven by electrodes for the movable member, not shown, as in the case of the aforementioned scanning unit 200. The electrodes for the movable member are a drive unit for driving the movable member 104.

On the other hand, there is no drive unit specific for the reflection mirror 605 provided. The reflection mirror 605 is displaced in association with the movable member 104, and corrects the position of the laser beam using the oscillations from the movable member 104 which is driven using the electrodes for the movable member. When the movable member 104 resonates in the X-direction as the first direction, the reflection mirror 605 also generates resonant oscillations from off balance due to deflection of the third torsion spring 212 or slight unbalancing caused by the manufacture error. The reflection mirror 605 is designed to resonate in the Y-direction as the second direction at a frequency higher than the resonance of the movable member 104 in the X-direction, for example, at about twice the frequency thereof. Accordingly, the reflection mirror 605 corrects the position of the laser beam using the oscillations from the movable member 104.

Furthermore, the third torsion spring 212 connects the reflection mirror 605 and the fixed portion 211 at a position shifted from the centerline X of the movable member 104. For example, as shown in FIG. 6, the reflection mirror 605 is connected to the third torsion spring 212 at an upper position and the lower position with respect to the centerline X. By disposing the axis of rotation of the reflection mirror 605 obliquely, the structure in which the reflection mirror 605 can easily generate the oscillations using the oscillations of the movable member 104 is achieved. In this manner, by employing the structure in which the reflection mirror 605 is off balance with respect to the movable member 104, the reflection mirror 605 can generate the oscillations easily using the oscillations of the movable member 104. The reflection mirror 605 can continue the oscillations stably after having started the oscillations once using the oscillations of the movable member 104.

The reflection mirror 205 described above has the structure in which the position of the laser beam is corrected by allowing the laser beam to be scanned in the second direction. In contrast, the reflection mirror 605 of this modification scans the laser beam in an oblique direction which is different from the first and the second directions in order to correct the position of the laser beam. In this case as well, it is possible to correct the position of the laser beam to be scanned. In this manner, the light scanning device 120 must simply have the structure in which the laser beam is scanned in the direction different from the first direction for correcting the position of the laser beam, and is not limited to the structure in which the correction is performed by scanning the laser beam in the second direction.

Since the reflection mirror 605 is displaced so as to correct the position of the laser beam using the oscillations from the movable member 104, the specific drive unit for correction is not necessary. Accordingly, the position of the laser beam to be scanned can be corrected with a further simple structure. It is also possible to provide the third torsion spring 212 on the centerline X as long as the reflection mirror 605 can easily generate the oscillations using the oscillations of the movable member 104. When the position of the laser beam is corrected in the oblique direction which is different from the first and second direction, the position of the laser beam is shifted not only in the second direction, but also in the first direction. The shift of the laser beam in the first direction in this case can be compensated by adjusting a timing of modulation of the laser beam at the light source 101 as needed.

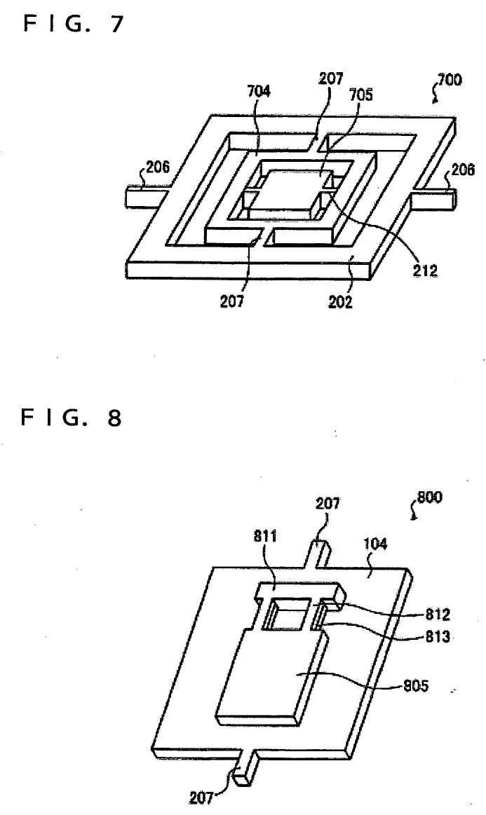

FIG. 7 shows a schematic structure of a scanning unit 700 according to a modification of the first embodiment. The scanning unit 700 can be applied to the above-described light scanning device 120. The scanning unit 700 of this modification is characterized in that the outer frame 202, a movable unit 704, and a reflection mirror 705 constitute a so-called triple gimbal structure. The movable unit 704 is provided around the reflection mirror 705. The reflection mirror 705 is connected to the movable unit 704 by the third torsion spring 212. In this modification as well, the third torsion spring 212 can be shifted from a centerline of the movable unit 704.

FIG. 8 is a schematic structure of a principal portion of a scanning unit 800 according to a modification of the first embodiment, illustrating the structure of the movable member 104 and the reflection mirror 805. The scanning unit 800 in this modification is characterized in that a cantilever 812 is provided on one side of a reflection mirror 805. The reflection mirror 805 is connected to a fixed portion 811 by the cantilever 812. The reflection mirror 805 is displaced so as to vary its inclination using torsion and restoration to its original state of the cantilever 812. In this modification as well, it is also possible to provide the movable member 104 around the reflection mirror 805.

In the case where the scanning portions 700, 800 in this modification are used as well, the position of the laser beam to be scanned can be corrected as in the case where the aforementioned scanning unit 200 is used. The reflection mirror 705 of the scanning unit 700 and the reflection mirror 805 of the scanning unit 800 may have a structure of being driven by a specific drive unit, or may have a structure of being oscillated by the oscillations of the movable member 104. In addition, the scanning member 800 shown in FIG. 8 may be a bimorph actuator employing layers having different coefficients of thermal expansion. For example, a layer 813 having different coefficient of thermal expansion from the member constituting the surface layer of the reflection mirror 805 is provided on the cantilever 812. Then, heat is supplied to the reflection mirror 805 by the supply of electric current to the reflection mirror 805.

For example, when the surface layer is expanded significantly by heat with respect to the layer 813 of the cantilever 812, the cantilever 812 is deformed so as to be bent. When supply of heat to the reflection mirror 805 is stopped, the cantilever 812 is restored to its original state. In this manner, the reflection mirror 805 can be displaced. In addition, the reflection mirror 805 is not limited to the structure of being displaced by the expansion of the surface layer of the cantilever 812, but may have a structure in which the layer 813 is shrunk with respect to the surface layer.

### Second Embodiment

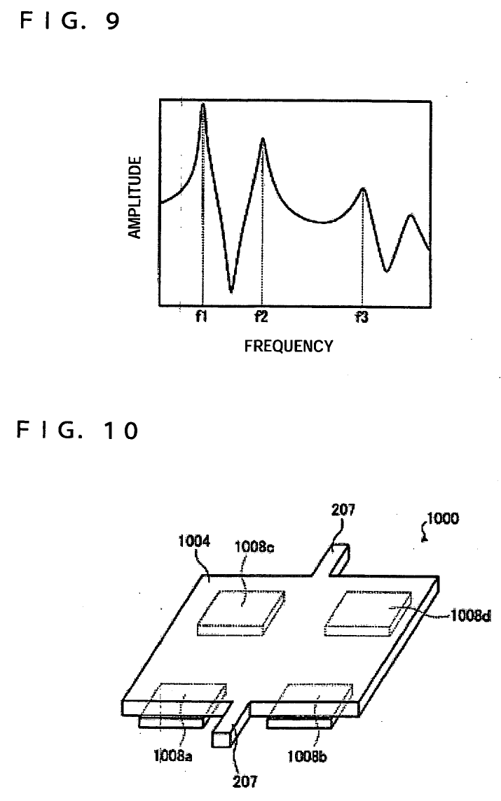

FIG. 9 is an explanatory drawing showing the positional correction of the laser beam with the light scanning device according to a second embodiment of the invention. The light scanning device of this embodiment can be applied to the image display apparatus 100 according to the above-described first embodiment. Description of the portions overlapped with those in the first embodiment will be omitted. In the first embodiment, the reflection mirror is provided on the movable member connected to the outer frame. In contrast, this embodiment is characterized in that the position of the light beam to be scanned is corrected by the reflection mirror connected to the outer frame.

A graph shown in FIG. 9 represents the amplitude on the axis of ordinate and the frequency on the axis of abscissas, and illustrates an example of the amplitude of the reflection mirror with respect to the driving frequency. The reflection mirror is displaced so as to reflect the laser beam from the light source, and scan the reflected laser beam in the first direction and in the second direction which is substantially orthogonal to the first direction. The reflection mirror has a structure of resonate about the axis of rotation for scanning the laser beam in the first direction as in the case of the movable member 104 of the first embodiment. The reflection mirror employs a resonant frequency f1 which can increase the amplitude to the maximum for the displacement for allowing the laser beam to be scanned in the first direction. The amplitude shown in FIG. 9 is not limited as far as the direction of oscillations of the reflection mirror is concerned.

In this embodiment, the reflection mirror corrects the position of the laser beam to be scanned by resonating so as to allow the laser beam to be scanned in the direction different from the first direction at a frequency higher than the frequency for scanning the laser beam in the first direction. The structure such as the reflection mirror may achieve translational displacement and rotational displacement in the three-dimensional direction. The reflection mirror of this embodiment is not only displaced in such a manner that the laser light draws a sine curve two-dimensionally, but also displaced in such a manner that the position to be scanned by the laser beam is corrected by adjusting the structure of the torsion spring or the action of the drive force.

For example, the reflection mirror is configured to scan the laser beam in the direction different from the first direction, for example, in the second direction, by resonating at the resonant frequency f2 which is substantially twice the resonant frequency f1. The reflection mirror allows the laser beam to be scanned in the first direction by resonating at the resonance frequency f1 and allows the laser beam to be scanned in the second direction for correcting the position of the laser by resonating at the resonant frequency f2.

As described in conjunction with the first embodiment, scanning for correcting the position of the laser beam may be performed at an amplitude smaller than that for scanning the laser beam in the first direction. Therefore, it is quite possible to correct the position of the laser beam by using the resonant frequency f2 that resonate at an amplitude smaller than the amplitude of the resonant frequency f1. The structure for correcting the position of the laser beam is not limited to the structure in which the reflection mirror is resonated at the resonant frequency f2. In order to correct the position of the laser beam, a resonant frequency larger than the resonant frequency f1 is used. For example, a resonant frequency f3 which is substantially four times the resonant frequency f1 may be employed. The resonant at the resonant frequency larger than the resonant frequency f1 is referred to as a high-order resonant, hereinafter.

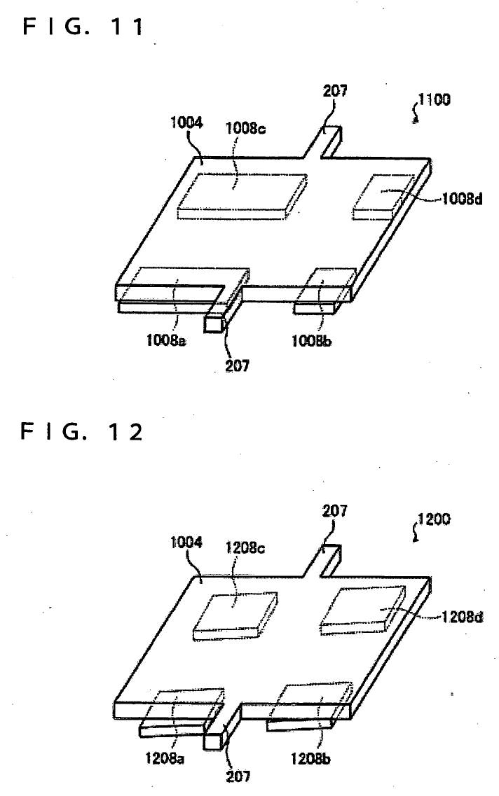

FIG. 10 shows a schematic structure of a principal portion of the scanning unit 1000 of this embodiment, illustrating a reflection mirror 1004 and a structure for driving the reflection mirror 1004. Parts identical to those in the first embodiment are represented by the identical reference numerals. There are provided four electrodes 1008a, 1008b, 1008c, and 1008d for a reflection mirror in a space on the back side of the reflection mirror 1004. The electrodes 1008a, 1008b, 1008c, and 1008d are a drive unit for driving the reflection mirror 1004. The reflection mirror 1004 corrects the position of the light beam to be scanned according to an electrostatic force, which is a drive force generated by the respective electrodes 1008a, 1008b, 1008c, and 1008d. The electrostatic force can be adjusted according to the voltage applied between the reflection mirror 1004 and the electrodes 1008a, 1008b, 1008c and 1008d.

Two of the electrodes 1008a, 1008c are provided on one side of the second torsion spring 207, and two of the electrodes 1008b, 1008d are provided on the other side. The reflection mirror 1004 is displaced so as to scan the laser beam in the second direction by the rotation of the outer frame as in the case of the movable member 104 of the first embodiment. The reflection mirror 1004 is displaced to allow the laser beam to be scanned in the first direction by applying the voltage alternately to the two electrodes 1008a, 1008c and to the two electrodes 1008b, 1008d.

Furthermore, the reflection mirror 1004 can generate a high-order resonant by varying the voltage between the electrode 1008a and the electrode 1008c and the voltage between the electrode 1008b and the electrode 1008d as needed. When the voltages to be applied to the electrodes 1008a, 1008b, 1008c and 1008d are represented by A, B, C and D, for example, the voltage is varied first to be A>B, B>A for the electrodes 1008a and 1008b, and then to be C>D, D>C for the electrodes 1008c and 1008d. The magnitude of the electrostatic force between the electrodes 1008a, 1008b, 1008c, and 1008d and the reflection mirror 1004 is varied by varying the applied voltage in this manner. The reflection mirror 1004 resonates at high-order so as to correct the position of the laser beam to be scanned by varying the magnitude of the electrostatic force for each electrode.

The reflection mirror 1004 can correct the position of the laser beam by a structure such that the high-order resonant is possible and the direction of high-order resonant corresponds to the direction to allow the laser beam to be scanned in the second direction. The structure of the reflection mirror 1004 is not limited to the structure in which the position of the laser beam is corrected by scanning the laser beam in the second direction as long as it is configured to correct the position of the laser beam by scanning the laser beam in the direction other than the first direction by resonance.

The laser beam can be scanned accurately corresponding to the two-dimensionally arranged pixels as in the first embodiment by correcting the position of the laser beam using the reflection mirror 1004. Since it is not necessary to provide a new mirror for correcting the position of the laser beam to be scanned, upsizing or complication in structure of the light scanning device 120 can be avoided. Accordingly, an advantage such that the laser beam can be scanned accurately corresponding to the arrangement of the pixels is achieved. The reflection mirror 1004 is not limited to the structure having four electrodes for correcting the position of the laser beam as long as there are a plurality of the electrodes.

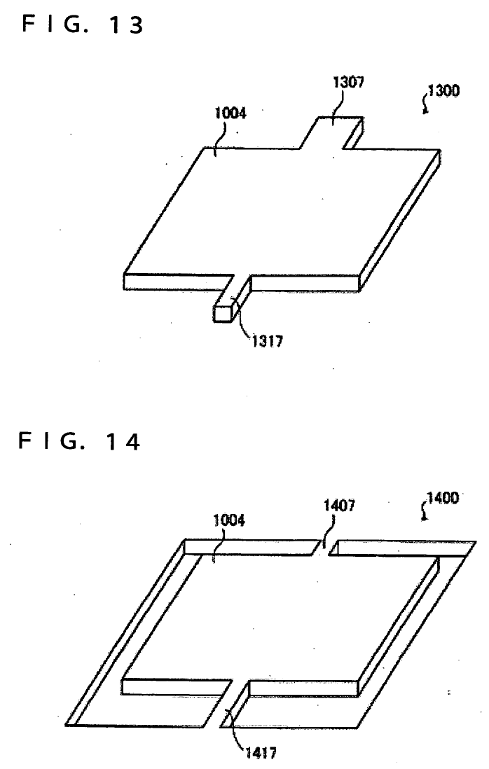

The scanning unit is not limited to the structure in which the magnitude of the electrostatic force is adjusted by varying the voltages applied to the respective electrodes. The magnitude of the electrostatic force can be adjusted by differentiating the size of the electrode like a scanning unit 1100 shown in FIG. 11. For example, as shown in FIG. 11, electrodes 1108a, 1108c provided on one side of the torsion spring 207 are larger in surface area than electrodes 1108b, 1108d provided on the other side. When a uniform voltage is applied to the respective electrodes, an electrostatic force stronger than the side where the electrodes 1108b, 1108d are provided is generated on the side where the electrodes 1108a, 1108c are provided. In this manner, by bringing the unbalanced electrostatic force to act on the structure of the reflecting mirror 1004, the high-order resonance can be generated. Furthermore, as a scanning unit 1200 shown in FIG. 12, the unbalanced electrostatic force may be brought to act on the structure of the reflection mirror 1004 by employing electrodes 1208a, 1208b, 1208c, 1208d of substantially the same size and differentiating the distance of the reflection mirror 1004 with respect to the respective electrodes.

The reflection mirror 1004 is not limited to a structure in which the position of the light beam to be scanned is corrected by using the electrostatic force. For example, in addition to the electrostatic force, the driving force may be the expansion force of the piezoelectric element or the electromagnetic force. When driving the reflection mirror 1004 by the expansion force of the piezoelectric element, a structure in which voltage is applied to the piezoelectric element as the drive unit may be employed. When driving the reflection mirror 1004 using the piezoelectric element, the magnitude of the expansion force can be adjusted according to the voltage applied to the piezoelectric element or the size of the piezoelectric material. In order to drive the reflection mirror 1004 by the electromagnetic force, a structure in which a coil and a magnet are provided as a drive unit, and electric current is supplied to the coil may be employed. When driving the reflection mirror 1004 by the electromagnetic force, the magnitude of the electromagnetic force can be adjusted according to the amount of electric current supplied to the coil, the number of turns of the coil, and the strength of the magnet.

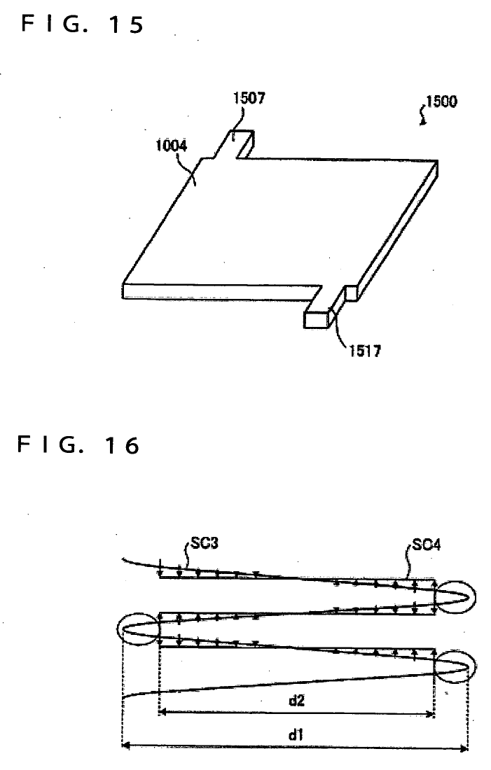

The reflection mirror 1004 is not limited to a structure in which the high-order resonance is generated by adjusting the magnitude of the drive force, and may have a structure in which the high-order resonance is generated by adjusting the shape of the torsion spring as the axis of rotation. For example, a structure in which torsion springs 1307, 1317 having different thickness are employed as a scanning unit 1300 shown in FIG. 13 may also be applicable. The torsion springs 1307, 1317 are axes of rotation for oscillating the reflection mirror 1004 so as to allow the laser beam to be scanned in the first direction. The torsion spring 1307 is formed to be thicker than the torsion spring 1317. A structure in which torsion springs 1407, 1417 being different in length are employed as a scanning unit 1400 shown in FIG. 14 may also be applicable. In this manner, by providing axis of rotation having an unbalanced shape in the structure of the reflection mirror 1004, a state in which the reflection mirror 1004 can resonate to allow the laser beam to be scanned in the direction different from the first direction may be created.

Furthermore, positions to provide torsion springs 1507, 1517 may be adjusted to be positions other than on the centerline of the reflection mirror 1004 as a scanning unit 1500 shown in FIG. 15. By providing the torsion springs 1507, 1517 at unbalanced positions in the structure of the reflection mirror 1004 as well, the state in which the reflection mirror 1004 can resonate to allow the laser beam to be scanned in the direction different from the first direction may be created. It is also possible to cause the high-order resonance in the reflection mirror 1004 by combining any of the structures shown in FIG. 10 to FIG. 15.

In order to approximate the track of the laser beam to the track SC2 of the rectangular shape as shown in FIG. 4, the mirror 1004 is preferably displaced as represented by the wave form substantially of the triangular shape shown in FIG. 5 to correct the position of the laser beam. In contrast, the reflection mirror 1004 of this embodiment corrects the position of the laser beam by resonance. Since the reflection mirror 1004 corrects the position of the laser beam by resonance, it is displaced as indicated by the sine curve.

Therefore, in this embodiment, in order to achieve the correction as approximating the track of the laser beam to the track SC4 of a rectangular shape shown in FIG. 16, the width d2 of the display area of the image may be set to be smaller than the width d1 that can be scanned by the laser beam. While the supply of the laser beam is stopped in the circled areas of a scanning track SC3 shown in FIG. 16, the reflection mirror 1004 resonated for correction is returned to allow the laser beam to be deflected downward in the drawing, which corresponds to the minus Y-direction. When the reflection mirror 1004 is in the high-order resonance at the resonant frequency f2, which is substantially twice the resonant frequency f1, for allowing the laser beam to be scanned in the first direction, the position of the reflection mirror 1004 is returned using a time period corresponding to one-fourth the cycle for allowing the laser beam to be scanned in the first direction.

The scanning speed of the laser beam is slow at the circled portions in FIG. 16 in comparison with other portions. Therefore, by displaying the image, for example, in the width d2 which is about 70% of the scanning width d1, a time period for returning the reflection mirrors 1004 in the high-order resonance to a position for allowing the laser beam to be deflected in the minus Y-direction can be secured. Accordingly, correction such as to approximate the track of the laser beam to the track SC4 in the rectangular shape can be made.

### Third Embodiment

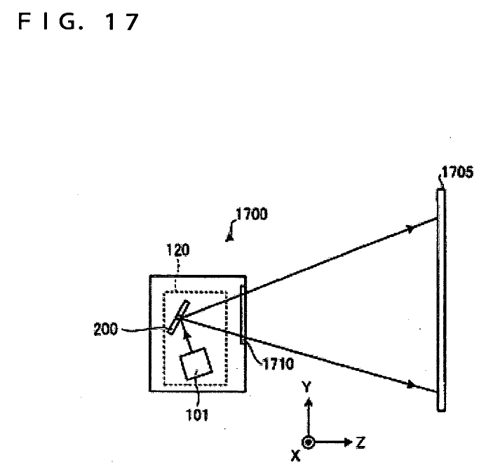

FIG. 17 shows a schematic structure of an image display apparatus 1700 according to the third embodiment of the invention. Parts identical to those in the first embodiment are represented by the identical reference numerals, and overlapped description is omitted. The image display apparatus 1700 is a so-called front projecting type projector which supplies the laser beam to a screen 1705 provided on the viewer's side and a viewer observes the light beam reflected on a screen 1705 to see the image. The image display apparatus 1700 has the light scanning device 120 as in the first embodiment.

A light-emitting window 1710 formed of a transparent material such as glass or transparent resin is provided on the surface of the image display apparatus 1700 on the viewer's side. The laser beam from the light scanning device 120 passes through the light-emitting window 1710 and then enters the screen 1705. By employing the light scanning device 120, the laser beam can be scanned accurately corresponding to the two-dimensionally arranged pixels. Accordingly, the image display apparatus 1700 can display high-quality images.

In the above described embodiments, the light scanning device 120 uses the light source 101 for supplying the laser beam. However, it is not limited thereto as long as it has a structure that can supply light in the form of a beam. For example, the light source 101 may have a structure employing a solid light-emitting element such as a light-emitting diode (LED). The light scanning device 120 of the invention may be used for electronic equipment for scanning laser beams such as laser printers in addition to the image display apparatus. When the light scanning device 120 is employed in the laser printer, high-quality printing images with misalignment of pixels reduced can be formed.

As described thus far, the light scanning device according to the invention is suitable to be used in the image display apparatus and the like that scans the light beam according to the image signals.

The entire disclosure of Japanese Patent Application no. 2005-038734, filed Feb. 16, 2005 is expressly incorporated by reference herein.

What is claimed is:

1. A light scanning device comprising:
a light source that supplies light in the form of a beam;
a reflection mirror that reflects the light beam from the light source; and
a movable member that is provided integrally with the reflection mirror and displaces the light beam reflected from the reflection mirror so as to be scanned in a first direction and in a second direction substantially orthogonal to the first direction, the movable member being displaced so that a frequency to scan the light beam in the first direction becomes higher than the frequency to scan the light beam in the second direction, the reflection mirror being displaced not only in association with the movable member but also for allowing the light beam to be scanned in a direction different from the first direction and correcting the position of the light beam to be scanned in accordance with displacement of the movable member.

2. The light scanning device according to claim 1 wherein the reflection mirror corrects the position of the light beam to be scanned by being displaced so as to allow the light beam to be scanned in the second direction.

3. The light scanning device according to claim 1 wherein the reflection mirror corrects the position of the light beam to be scanned by being displaced at a higher frequency than a frequency at which the movable member is displaced to scan the light beam in the first direction.

4. The light scanning device according to claim 1 wherein the reflection mirror corrects the position of the light beam to be scanned by being displaced at a frequency which corresponds to substantially twice the frequency at which the movable member is displaced to scan the light beam in the first direction.

5. The light scanning device according to claim 1 comprising:
a first drive unit that drives the movable member and
a second drive unit that drives the reflection mirror for correcting the position of the light beam.

6. The light scanning device according to claim 1 comprising: the drive unit that drives the movable member,
wherein the reflection mirror is displaced so as to correct the position of the light beam to be scanned using oscillations from the movable member that is driven by the drive unit.

7. A light scanning device comprising:
a light source that supplies a light beam;
a reflection mirror that reflects the light beam from the light source and is displaced so that the reflected light beam is scanned in a first direction and a second direction substantially orthogonal to the first direction, the reflection mirror being displaced so that a frequency to scan the light beam in the first direction becomes higher than a frequency to scan the light beam in the second direction and correcting the position of the light beam to be scanned by resonating so as to allow the light beam to be scanned in a direction different from the first direction at a frequency higher than a frequency to scan the light beam in the first direction.

8. The light scanning device according to claim 7, comprising:
a drive unit that drives the reflection mirror,
wherein the reflection mirror corrects the position of the light beam to be scanned according to a driving force generated by the drive unit.

9. The light scanning device according to claim 8, wherein
a plurality of the drive units are provided; and
the reflection mirror corrects the position of the light beam to be scanned by adjusting the magnitude of the driving force for each drive unit.

10. The light scanning device according to claim 7 comprising:
an axis of rotation for oscillating the reflection mirror so as to allow the light beam to be scanned in the first direction,
wherein the reflection mirror corrects the position of the light beam to be scanned by adjusting at least one of the shape of the axis of rotation and the position to provide the axis of rotation.

11. An image display apparatus comprising the light scanning device according to claim 1, wherein an image is displayed on a predetermined surface by a light beam from the light scanning device.
